(19) United States
(12) Patent Application Publication
(10) Pub. No.: US 2026/0284737 A1
(43) Pub. Date: Sep. 24, 2026

(54) SAND CORE, SAND MOLD AND METHOD FOR MANUFACTURING A SAND CORE

(71) Applicant: ATLAS COPCO AIRPOWER, NAAMLOZE VENNOOTSCHAP, Wilrijk (BE)

(72) Inventors: Karolien KEMPEN, Wilrijk (BE); Rob HOOGMARTENS, Wilrijk (BE); Victor ADRIAENS, Wilrijk (BE)

(73) Assignee: ATLAS COPCO AIRPOWER, NAAMLOZE VENNOOTSCHAP, Wilrijk (BE)

(21) Appl. No.: 19/473,907

(22) PCT Filed: Apr. 11, 2024
(86) PCT No.: PCT/IB2024/053538

§ 371 Date: Oct. 9, 2025

Related U.S. Application Data
(60) Provisional application No. 63/459,075, filed on Apr. 13, 2023.

(30) Foreign Application Priority Data
Aug. 21, 2023 (BE) 2023/5693

(51) Int. Cl. B22C 9/10; B22C 9/02; B22C 9/08; B22D 25/02; B33Y 80/00

(52) U.S. Cl. CPC B22C 9/10; B22C 9/02; B22C 9/08; B22D 25/02; B33Y 80/00

(57) ABSTRACT

A sand core for casting a screw rotor comprising a main body having two head surfaces and a profile surface having helical lobes extending between the two head surfaces, wherein the sand core (1) includes an integral piece (2) having an internal cavity (3), wherein the internal cavity (3) is at least partially bounded by the integral piece (2) by means of a rotationally symmetric surface formed by helical grooves (5) about a rotationally symmetric axis, wherein the helical grooves (5) have a profile for forming the helical lobes during casting of the screw rotor, wherein an outer surface of the integral piece (2) is provided with an opening or a plurality of openings (4) extending into the internal cavity (3), wherein the opening or each of the plurality of openings (4) is adjacent to the helical grooves (5).

### CROSS-REFERENCE TO RELATED APPLICATIONS

This is a National Stage of International Application No. PCT/IB2024/053538 filed Apr. 11, 2024, claiming priority based on U.S. Provisional Application No. 63/459,075 Apr. 13, 2023 and Belgian Patent Application No. 2023/5693 filed Aug. 21, 2023.

### BACKGROUND OF THE INVENTION

### Field

The present invention relates to a sand core, to a sand mold, to a method for manufacturing a sand core, and to a method for casting a screw rotor comprising a main body having two head surfaces and a profile surface having helical lobes extending between these two head surfaces, for example a screw rotor for a compressor, vacuum pump or expander element.

More specifically, the invention relates to a sand core comprising an integral piece having an internal cavity for forming the helical lobes during the casting of the screw rotor.

### Background

Casting processes are known from the prior art in which molten casting material, typically gray or ductile cast iron, is poured into an internal mold cavity of a sand core in a sand mold via a runner.

When the mold cavity in the sand core is filled with this molten casting material, a casting is at least partially formed by a surface of the mold cavity.

In order to accurately cast the casting and avoid extensive finishing of the casting, the sand core typically has a closed structure so that the mold cavity surrounds the casting material in the sand core during the casting process as completely as possible.

For this reason, an outer surface of the sand core typically comprises only a limited number of openings to provide access to the internal mold cavity, for example:
an inlet or a plurality of inlets for pouring molten casting material into the mold cavity; and
an outlet or a plurality of outlets for degassing and for connecting the mold cavity to a riser or a plurality of risers in the sand mold.

Due to the limited number of openings in the outer surface, it may be difficult to grasp the sand core on the outer surface to place this sand core in or remove it from the sand mold.

It is also difficult to remove loose sand from the sand core or to clean the internal mold cavity of other contaminants due to a limited accessibility of the mold cavity, as well as a complex geometry of the mold cavity for a screw rotor having helical lobes as a casting.

For the same reasons, it is also difficult to provide the internal mold cavity with a coating before the casting process.

The coating protects the sand core from erosion and burn-in in the mold cavity during the casting process as a result of the high temperature of the molten casting material, wherein the erosion and the burn-in would result in rough zones on an external surface of the screw rotor resulting from the casting process.

After the coating has been applied and dried in the internal mold cavity, an excess of coating material must be evacuated from the mold cavity to prevent said excess coating material from accumulating during the casting process at locations in the mold cavity that should actually be filled with molten casting material, which would be detrimental to the quality and dimensional accuracy of the final casting. It goes without saying that the typically limited number of openings in the outer surface of the sand core with access to the internal mold cavity is not conducive to evacuating the excess coating material from the sand core.

When designing the sand core, it is also necessary to consider the position, number and size of the inlet or the plurality of inlets, which will have a decisive influence on the uniform and complete filling of the mold cavity with casting material during the casting process, and thus on the quality of the casting resulting from the casting process.

The position, number and size of the outlet or the plurality of outlets that are connected to the riser or the plurality of risers or to one or more degassing channels in the sand mold during the casting process also affect the quality of the resulting casting.

During the casting process, the riser or each of the risers first acts as a venting channel so that air inclusions can be avoided in the resulting casting.

Then, once the mold cavity is completely or almost completely filled with casting material, the riser or each of the risers acts as a reservoir for excess molten casting material, from which reservoir molten casting material can be drawn back to and into the mold cavity as the casting shrinks during the solidification of said casting. In this way, formation of holes in the casting that are not filled with casting material due to the shrinking of the casting during solidification is avoided.

The position, number and size of the outlet or plurality of outlets is therefore critical for reducing the number and/or volume or avoiding these holes in the casting that are not filled with casting material.

Due to the complex geometry of the mold cavity, it is difficult or impossible to reduce and/or eliminate the formation of holes not filled with casting material in the casting with a limited number of outlets in the sand core when the screw rotor is cast horizontally.

In this case, “horizontal casting” means that a rotationally symmetrical axis of the mold cavity, which coincides with the rotationally symmetrical axis of the cast screw rotor after the screw rotor has been formed in the sand core by filling the mold cavity with casting material, extends in a gravitational horizontal plane.

A “gravitational horizontal plane” means a plane perpendicular to a direction in which a principal gravity, typically the gravitational pull of the earth, is exerted on the casting material. In other words, a “gravitational horizontal plane” means a plane that is level oriented.

When the screw rotor is cast horizontally, impurities that would be present in the molten casting material and/or inhomogeneities that would occur during the solidification of the casting material in the mold cavity cannot be removed from the mold cavity through the limited number of outlets by means of flotation on the still molten casting material in the mold cavity. For example, for rotors cast in EN-GJS-450-10 ductile iron, the aforementioned inhomogeneities occur in the form of oxide slags and graphite flotation.

When these impurities and/or inhomogeneities become trapped in the material of the screw rotor resulting from the casting process during the solidification of the casting material in the mold cavity, they cause an uneven distribution of weight and consequently an imbalance around the rotationally symmetric axis of said screw rotor. The presence of impurities and/or inhomogeneities in the material of the resulting screw rotor can also have a negative influence on surface quality and/or mechanical properties of said screw rotor, such as strength and/or stiffness.

For the above reasons, the quality of a screw rotor that is horizontally cast with a limited number of outlets typically does not meet certain predetermined requirements and/or the external surface of said screw rotor still needs to be machined to considerable depth after the casting process. This results in formation of waste material and increases a finishing time and finishing cost of the screw rotor.

In addition, a sand core having an integral piece for forming the helical lobes of the screw rotor has the disadvantage that a surface of the internal cavity in the integral piece for forming the helical lobes typically comprises slightly conical helical grooves with a constant pitch. The reason for this is that the internal cavity in such an integral piece is typically formed by a mold or master with a shape corresponding to the screw rotor. The helical grooves must be slightly conical and have a constant pitch to allow the mold to be screwed back out of the integral piece without obstruction after the formation of the integral piece.

As a result, the screw rotor resulting from the casting process of course also has slightly conical helical lobes with a constant pitch. To make the helical lobes parallel helical, i.e., helical with a constant radius, another extensive finishing step of the resulting screw rotor is required. Such a finishing step requires a certain finishing time and finishing cost and results in an unwanted formation of waste material.

To remove the mold from the integral piece, an outer surface of said integral piece must also comprise a large opening having a diameter equal to or greater than a largest diameter of the mold.

In addition, manufacturing the mold is an expensive, time-consuming, and energy-intensive process due to the large number of process steps involved, such as purchasing material; heat treating the material; turning, milling and grinding the material; nickel plating; post-measurement; and shipping the mold.

As a result, manufacturing the mold is often a one-time, non-iterative activity, wherein a buffer allowance is provided to compensate for deviations and shrinkage behavior of the casting material during the casting process. Because of this buffer allowance, further finishing of the screw rotor resulting from the casting process is required after the casting process.

Finally, horizontal casting of screw rotors has the disadvantage that a vertical height of the sand mold is a limiting factor for an outer diameter of the cast screw rotor.

A vertical dimension of the sand core must be smaller than the vertical height of the sand mold. The outer diameter of the screw rotor resulting from the casting process is limited by this vertical dimension of the sand core and by a minimum thickness of a wall of the integral piece of the sand core around the internal cavity.

On the other hand, when horizontally casting screw rotors with a limited outer diameter, the vertical height of an available sand mold can be much larger than the vertical dimension of the sand core, whereby a lot of useful space in said available sand mold is lost.

In other words, when horizontally casting screw rotors, the vertical height of the sand mold is usually not adapted or flexibly adaptable to the outer diameter of the screw rotor to be cast, resulting in a loss of efficiency in the casting process in terms of production time and production cost.

### SUMMARY OF THE INVENTION

This invention aims at solving at least one of the aforementioned disadvantages and/or other disadvantages.

More specifically, the object of the present invention is to provide a sand core and/or sand mold for casting a screw rotor in a fast, inexpensive, accurate and/or flexible manner, for example with minimum finishing allowances to achieve a certain desired final quality.

The present invention can also have the object of efficiently utilizing an available space in the sand mold to minimize the time and cost required to cast one or more screw rotors.

The invention also has the object of providing a fast, inexpensive, accurate and/or flexible method for manufacturing the sand core.

Finally, the present can have the object of providing a fast, inexpensive, accurate and/or flexible method for casting a screw rotor optionally having a complex geometry, for example a screw rotor having helical lobes with a variable pitch.

For this purpose, the invention relates to a sand core for casting a screw rotor, the screw rotor comprising a main body having two head surfaces and a profile surface having helical lobes extending between the two head surfaces,
wherein the sand core comprises an integral piece having an internal cavity,
wherein the internal cavity is at least partially bounded by the integral piece by means of a rotationally symmetric surface formed by helical grooves about a rotationally symmetric axis, wherein the helical grooves have a profile for forming the helical lobes during the casting of the screw rotor,
wherein an outer surface of the integral piece is provided with an opening or a plurality of openings extending into the internal cavity,
characterized in that,
the opening or each of the plurality of openings is adjacent to the helical grooves.

Because of the opening or plurality of openings, a mold cavity of the sand core according to the invention is easily accessible, in particular the helical grooves of the internal cavity, whereby the helical lobes of the screw rotor are formed during the casting process.

Since loose sand and impurities in the mold cavity accumulate mainly in these helical grooves, said loose sand and impurities are easily removed from the sand core through the opening or plurality of openings.

Conversely, a coating can be easily applied to a surface of the internal cavity of the integral piece through the opening or plurality of openings to reduce or even eliminate rough zones on an external surface of the screw rotor resulting from the casting process. After the coating is applied in the internal cavity, excess coating material that accumulates in the helical grooves of the internal cavity can also escape through the opening or plurality of openings.

Therefore, the sand core according to the invention can be used to cast a screw rotor having a complex geometry and a higher quality and dimensional accuracy than is the case with known sand cores. As a result, when the sand core according to the invention is used for casting the screw rotor, there is also less formation of waste material, less energy consumption and less finishing time and costs required than in the case of known sand cores.

By making the opening or each of the plurality of openings adjacent to the helical grooves of the internal cavity, it is also possible to eliminate a distance between the outer surface of the integral piece and the internal cavity of the integral piece of the sand core.

In other words, when the screw rotor is cast horizontally, the integral piece of the sand core has a minimum vertical dimension for a given outer diameter of the screw rotor to be cast.

As a result, the sand core according to the invention is lighter than known sand cores. Together with a favorable position of the opening or openings in the outer surface of the integral piece, this makes the sand core according to the invention easy to handle.

Furthermore, when the screw rotor is cast horizontally, for a given outer diameter of the screw rotor to be cast, the sand core will fit in the sand mold with a smaller vertical height. If the vertical height of the sand mold is fixed, the sand core according to the invention, when the screw rotor is cast horizontally, leaves more vertical space in the sand mold free for casting still other castings in the sand mold.

In a preferred embodiment of the sand core according to the invention, the internal cavity is additionally bounded by the integral piece by means of two end surfaces that are configured to form the two head surfaces during the casting of the screw rotor.

This can be achieved, for example, by manufacturing the sand core entirely by means of additive production techniques rather than forming the internal cavity in the sand core by means of a mold having conical helical lobes corresponding to the helical lobes of the screw rotor to be cast.

As a result, there is no need to remove a mold from the integral piece when manufacturing the sand core. Thus, the integral piece also does not need to comprise a large opening having a diameter equal to or greater than a largest diameter of the mold. The presence of such a large opening in the integral piece would prevent at least one of the head surfaces from being formed by the internal cavity in the integral piece.

As a result, this preferred embodiment of the sand core according to the invention has the advantage that in addition to the helical lobes of the profile surface, the two head surfaces of the screw rotor can also be formed by the internal cavity in the integral piece.

In this case, the integral piece is preferably provided with two cylindrical holes, wherein each of the two cylindrical holes is adjacent to the outer surface and one of the two end surfaces.

Two axle journals of the screw rotor can be cast through these cylindrical holes, wherein each of the axle journals protrudes from one of the head surfaces of the main body of the screw rotor. At the level of these axle journals, the screw rotor can be supported by bearings in a housing of a compressor element, vacuum pump element or expander element.

In existing sand cores whereby the integral piece is manufactured using a mold or master, only one first axle journal can be formed by the integral piece because the mold must be removed from the integral piece on a side of the integral piece where the second axle journal is to be. To remove the mold on this side of the integral piece, the integral piece must have an opening on this side having a diameter that is at least equal to the outer diameter of the mold, which outer diameter is typically larger than an outer diameter of the second axle journal, whereby the second axle journal cannot be formed by the integral piece.

By forming both axle journals on the main body of the screw rotor with the integral piece, it is possible to more easily measure, check and if necessary correct an alignment and thus stability of clamping for the casting in a clamping device for a further machining step.

In a further preferred embodiment of the sand core according to the invention, the helical slots are parallel helical.

In this context, “parallel helical” means that the helical grooves have a constant outside radius, or in other words, the helical grooves are not conically helical, wherein an outside radius of the helical grooves would be converging or diverging.

This can be achieved, for example, by manufacturing the sand core entirely by means of additive production techniques rather than forming the internal cavity in the sand core by means of a mold having conical helical lobes corresponding to the helical lobes of the screw rotor to be cast.

This preferred embodiment of the sand core according to the invention has the advantage that the screw rotor resulting from the casting process no longer needs to be finished to make the helical lobes of the profile surface parallel helical.

As a result, the formation of waste material can be reduced, a production time of the screw rotor can be shortened, and production costs of the screw rotor can be reduced.

In a further preferred embodiment of the sand core according to the invention, the helical grooves have a variable pitch.

This can be achieved, for example, by manufacturing the sand core entirely by means of additive production techniques rather than forming the internal cavity in the sand core by means of a mold having conical helical lobes corresponding to the helical lobes of the screw rotor to be cast.

This has the advantage that the sand core according to the invention can be used to cast a screw rotor having a profile surface of helical lobes with a variable pitch, and that the screw rotor does not need to be finished after casting in order to realize the variable pitch of the helical lobes.

The use of such a screw rotor having helical lobes with a variable pitch in a vacuum pump element has the advantage of reducing pulsation in a gas flow through the vacuum pump element. This improves the overall efficiency of the vacuum pump element through lower energy consumption, quieter operation, more uniform temperature distribution and therefore lower cooling water consumption.

The use of such a screw rotor having helical lobes with a variable pitch in a compressor element has the advantage that throttling losses are reduced and a sealing line at the high pressure end of the compressor element is smaller. In a further preferred embodiment of the sand core according to the invention, a surface of the internal cavity is at least partially provided with a coating and the sand core is provided with bleed holes for discharging excess coating material from the internal cavity after providing the coating on the surface of the internal cavity.

The coating protects the sand core from erosion and burn-in in the mold cavity during the filling of the sand core with molten casting material due to a high temperature of the molten casting material, thereby reducing or eliminating rough zones on an external surface of the screw rotor resulting from the casting process.

By providing bleed holes in the sand core, it is possible to prevent excess coating material from accumulating in the sand core after the coating is provided on the surface of the internal cavity. Indeed, this would result in reduced quality and an imbalance in the weight of the screw rotor resulting from the casting process.

The invention also relates to a sand mold for casting a screw rotor, wherein the sand mold contains a sand core according to any of the above-described embodiments.

It goes without saying that such a sand mold according to the invention has the same advantages as the above-described embodiments of the sand core according to the invention.

In a preferred embodiment of the sand mold according to the invention, the sand mold is provided with a degassing channel or a plurality of degassing channels for degassing the internal cavity in the sand core during the casting of the screw rotor, wherein the degassing channel or each of the degassing channels is connected to the opening or at least one of the plurality of openings in the outer surface of the integral piece of the sand core.

The advantage is that the degassing channel or the degassing channels are fluidly connected to a location or a plurality of locations in the internal cavity where air or other gas accumulates when the screw rotor is cast horizontally and must be evacuated from the sand core, namely one or more helical grooves of the rotationally symmetric surface.

This eliminates the possibility of gas inclusions in the screw rotor resulting from the casting process, which benefits the mechanical properties and weight balance of said resulting screw rotor.

In a further preferred embodiment of the sand mold according to the invention, the sand mold is provided with a runner or a plurality of runners for pouring a liquid casting material into the internal cavity during the casting of the screw rotor, wherein the runner or each of the runners is connected to the opening or at least one of the plurality of openings in the outer surface of the integral piece of the sand core.

By connecting the runner or runners to the opening or at least one of the plurality of openings, the liquid casting material in the internal cavity first ends up in the helical grooves, thereby filling the internal cavity with the casting material in a uniform and complete manner. This benefits the mechanical properties and weight balance of the resulting screw rotor.

In a further preferred embodiment of the sand mold according to the invention, the sand mold contains a plurality of sand cores.

This has the advantage that the sand mold can be used to cast a plurality of screw rotors simultaneously, which implies a reduction in production time per screw rotor produced with the sand mold.

In this case, the sand cores are preferably arranged in the sand mold according to a triangular arrangement pattern.

This has the advantage that the available space in the sand mold can be utilized to the maximum and that the sand mold can contain as many sand cores as possible.

In this way, a production time per screw rotor produced with the sand mold is reduced to a minimum.

The invention also relates to a method for manufacturing a sand core for casting a screw rotor, the screw rotor comprising a main body having two head surfaces and a profile surface having helical lobes extending between the two head surfaces, characterized in that the sand core is manufactured by means of an additive production technique.

Manufacturing the sand core by means of additive production techniques has the advantage that a mold cavity of the sand core, and thus also the internal cavity of the integral piece of the sand core, can be formed with high dimensional accuracy.

In addition, additive production techniques allow the mold cavity, and thus also the internal cavity, to be formed with a complex geometry, such as the rotationally symmetric surface with helical grooves, with or without a variable pitch. As a result, screw rotors with complex geometry can be manufactured without extensive finishing steps after casting. This results in less formation of waste material and a shorter production time of the screw rotor.

The use of additive production techniques allows the sand core to be lighter and more compact than standard subtractive production techniques because additive production techniques apply material only where necessary to build the sand core.

Because of their flexibility, additive production techniques can also allow for quick and iterative dimensional optimization of a sand core design, resulting in even greater gains in terms of weight, production time, production cost and quality of the sand core and screw rotor resulting from the casting process.

In addition, additive production techniques can be used to optimize the sand core design to not only make process steps before the casting of the screw rotor, such as cleaning and coating the sand core, more efficient, but also to control the placement of the sand core and the casting process to ensure positional and dimensional stability.

In addition, with regard to the position and size of runner and degassing systems and with respect to heat exchanges and solidification processes in the sand core, additive production techniques entail a certain design freedom that allows optimization of temperature distributions and flows of the casting material in the sand core during the casting process for obtaining a screw rotor with a desired quality and intended mechanical properties.

In a preferred embodiment of the method according to the invention for manufacturing a sand core for casting a screw rotor, the sand core is according to any one of the above-described embodiments.

It goes without saying that the preferred embodiment of this method has the same advantages as the above-described embodiments of the sand core according to the invention.

The invention also relates to a method for casting a screw rotor, the screw rotor comprising a main body having two head surfaces and a profile surface having helical lobes extending between the two head surfaces, wherein the method comprises the following steps: filling a sand core according to any of above-described embodiments with a molten casting material; solidifying the casting material in the sand core to form the screw rotor, wherein the helical lobes in the internal cavity are formed by the profile of the helical grooves.

It goes without saying that such a method according to the invention for casting a screw rotor has the same advantages as the above-described embodiments of the sand core according to the invention.

In a preferred embodiment of the method according to the invention for casting a screw rotor, the aforementioned rotationally symmetric axis is oriented horizontally during the filling of the sand core.

The advantage of this is that the vertical height of a sand mold containing the sand core can be kept as small as possible, taking into account the fact that a dimension of the screw rotor along its rotationally symmetric axis is generally larger than an outer diameter of the screw rotor perpendicular to this rotationally symmetric axis.

In a further preferred embodiment of the method according to the invention for casting a screw rotor, a surface of the internal cavity is at least partially provided with a coating before the filling of the sand core; and excess coating material is removed from the internal cavity after the coating is provided on the surface of the internal cavity and before the filling of the sand core.

By providing the coating on a surface of the internal cavity before the filling the sand core, the internal cavity is at least partially protected from erosion and burn-in of the sand core during the casting process, thereby reducing or eliminating rough zones on an external surface of the screw rotor resulting from the casting process.

By removing excess coating material from the internal cavity after the coating is provided on the surface of the internal cavity, an accumulation of coating material in the sand core can be reduced or eliminated, resulting in improved quality and balance in the weight of the screw rotor resulting from the casting process.

In a further preferred embodiment of the method according to the invention for casting a screw rotor, the internal cavity is degassed through the opening or through one or more of the openings during the filling of the sand core.

The advantage is that the internal cavity is degassed at locations where air or other gas accumulates when the screw rotor is cast horizontally and must be evacuated from the sand core, namely in the one or more helical grooves of the rotationally symmetric surface.

This eliminates the possibility of gas inclusions in the screw rotor resulting from the casting process, which benefits the mechanical properties and weight balance of said resulting screw rotor.

In a further preferred embodiment of the method according to the invention for casting a screw rotor, the molten casting material is poured through the opening or through one or more of the openings in the internal cavity during the filling of the sand core.

By pouring the casting material through the opening or one of the plurality of openings, the liquid casting material in the internal cavity first ends up in the helical grooves, thereby filling the internal cavity with the casting material in a non-turbulent, uniform and complete manner. This benefits the mechanical properties and weight balance of the resulting screw rotor.

### BRIEF DESCRIPTION OF THE INVENTION

Hereafter, with the understanding to better demonstrate the characteristics of the invention, some preferred applications of a sand core, sand mold, and method for casting a screw rotor according to the invention are described with reference to the accompanying drawings, in which:

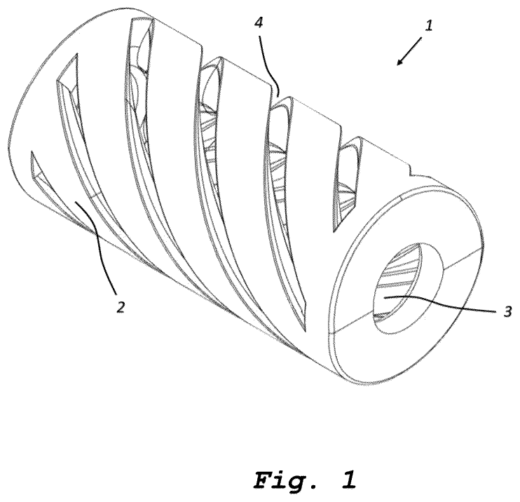

FIG. 1 is an external view of a sand core according to the invention;

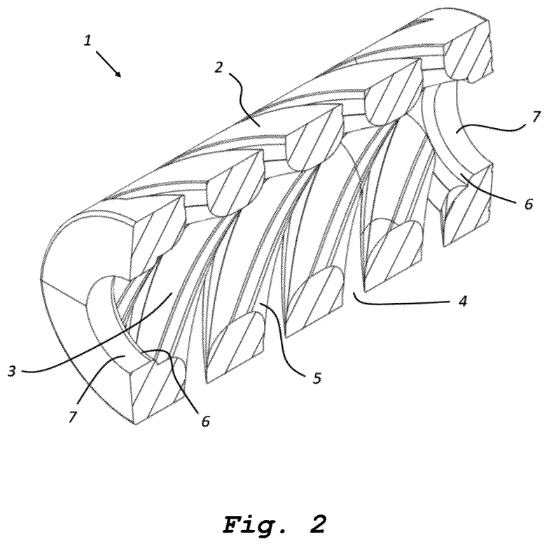

FIG. 2 shows a longitudinal section of the sand core in FIG. 1;

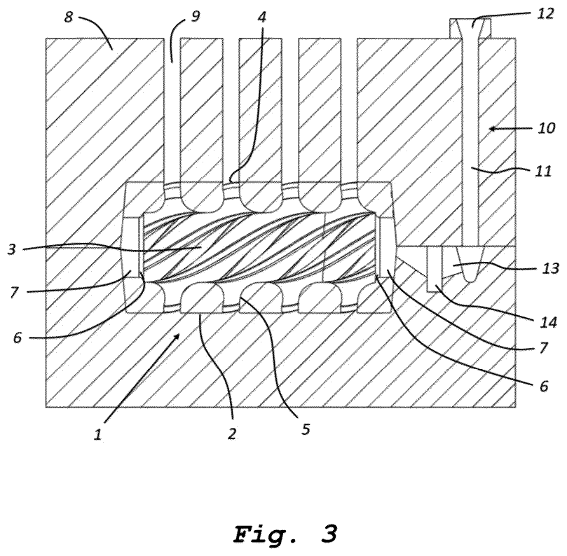

FIG. 3 shows a longitudinal section of a sand mold according to the invention with a sand core according to the invention; and

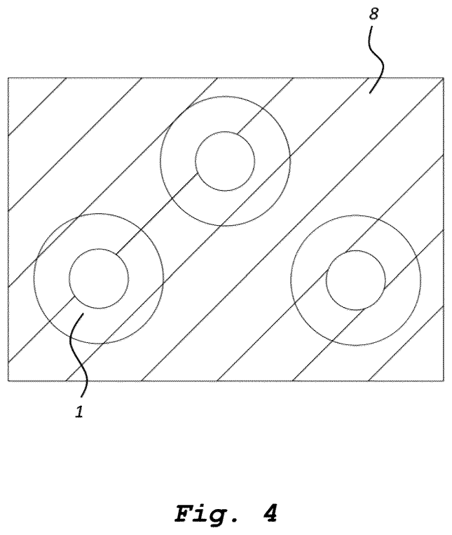

FIG. 4 shows a cross section of a sand mold according to the invention with a plurality of sand cores.

### DETAILED DESCRIPTION OF THE INVENTION

FIG. 1 shows a sand core 1 according to the invention for casting a screw rotor, the screw rotor comprising a main body having two head surfaces and a profile surface having helical lobes extending between the head surfaces.

The sand core 1 comprises an integral piece 2 having an internal cavity 3.

An outer surface of the integral piece 2 is provided with a number of openings 4, wherein each of the openings 4 extends into the internal cavity 3.

FIG. 2 shows a longitudinal section of the sand core 1 in FIG. 1.

In this longitudinal section of the sand core 1, it can be seen that the internal cavity 3 is at least partially bounded by the integral piece 2 by means of a rotationally symmetric surface formed by helical grooves 5 about a rotationally symmetric axis, wherein the helical grooves 5 have a profile that is configured to form the helical lobes during casting of the screw rotor.

In this case, it can also be seen that each of the openings 4 in the outer surface of the integral piece 2 is adjacent to one of the helical grooves 5.

In addition, the internal cavity 3 is bounded by an integral piece 2 by means of two end surfaces 6 that are configured to form the two head surfaces of the screw rotor to be cast.

In this case, the integral piece 2 is provided with two cylindrical holes 7, wherein each of the two cylindrical holes 7 is adjacent to the outer surface of the integral piece 2 and one of the two end surfaces 6.

Two axle journals of the screw rotor can be cast through these cylindrical holes 7, wherein each of the axle journals protrudes from one of the head surfaces of the main body of the screw rotor, for a bearing of the screw rotor in a housing of a compressor element, vacuum pump element or expander element.

The helical grooves 5 are parallel helical in FIG. 2 and have a constant pitch. However, within the scope of the invention, it is not ruled out that the helical grooves 5 are conically helical and/or have a variable pitch.

A surface of the internal cavity 3 can be at least partially provided with a coating to reduce or even eliminate rough zones on an external surface of the resulting from the casting process.

After the coating has been provided on the surface of the internal cavity 3, excess coating material can be discharged through bleed holes in the sand core 1 (not shown in the figures) to prevent excess coating material from accumulating at certain locations in the sand core 1.

FIG. 3 shows a longitudinal section of a sand mold 8 according to the invention for casting a screw rotor, wherein the sand mold 8 comprises a sand core 1 according to the invention.

The sand mold 8 is provided with a number of degassing channels 9 for degassing the integral cavity 3 in the sand core 1 during casting of the screw rotor. In this case, the degassing channels 9 are connected to the openings 4 in the outer surface of the integral piece 2 of the sand core 1.

Furthermore, the sand mold 8 is provided with a casting device 10 having a runner or a number of runners 11 along which molten casting material can be poured into the sand core 1 to fill the sand core 1 with casting material to form the screw rotor to be cast.

On the outside of the sand mold 8, the casting device 10 can comprise a pouring funnel 12 and/or a feed chute 13 at an inlet of the sand core 1. The feed chute 13 can be fitted with a metal filter 14. Advantages of such a metal filter 14 are described in Belgian patent BE 1027183 B1.

Within the scope of the invention, it is not ruled out that the sand mold 8 is provided with a number of runners that are connected to the openings 4 in the outer surface of the integral piece 2 of the sand core 1 so that the casting material is poured into the internal cavity 3 along the openings 4 (not shown in the figures).

FIG. 4 shows a cross section of a sand mold 8 according to the invention with a plurality of sand cores 1.

In this case, the sand cores 1 are arranged in the sand mold 8 according to a triangular arrangement pattern to make maximum use of the available space in the sand mold 8.

An example of a method according to the invention for casting a screw rotor, the screw rotor comprising a main body having two head surfaces and a profile surface having helical lobes extending between the two head surfaces is described below.

In a first step of the method according to the invention, a sand core 1 according to the invention is filled with a molten casting material.

In this case, the rotationally symmetric axis of the internal cavity 3 is oriented horizontally during the filling of the sand core 1.

According to the invention, it is not ruled out that the sand core 1 is first pre-treated before the sand core 1 is filled with molten casting material. For example, a surface of the internal cavity 3 can be at least partially provided with a coating to reduce or even eliminate rough zones on an external surface of the screw rotor resulting from the casting process. Excess coating material must then be removed from the internal cavity 3 after the coating is provided on the surface of the internal cavity 3.

As the sand core 1 is filled, the internal cavity 3 is degassed through the openings 4.

Analogously, the molten casting material can be poured into the internal cavity 3 through the openings 4 during the filling of the sand core 1.

Finally, the casting material is solidified in the sand core 1 to form the screw rotor, wherein the helical lobes in the internal cavity 3 of the integral piece 2 are formed by the profile of the helical grooves 5.

The invention is by no means limited to the sand core, sand mold and method described by way of example and shown in the figures, but a sand core or sand mold according to the invention can be realized in a variety of forms and dimensions, and a method according to the invention can be realized in a wide variety of versions, without exceeding the scope of protection of the invention as defined in the claims.

1. A sand core for casting a screw rotor, the screw rotor comprising a main body having two head surfaces and a profile surface having helical lobes extending between the two head surfaces,
wherein the sand core (1) comprises an integral piece (2) having an internal cavity (3), wherein the internal cavity (3) is at least partially bounded by the integral piece (2) by means of a rotationally symmetric surface formed by helical grooves (5) about a rotationally symmetric axis,
wherein the helical grooves (5) have a profile for forming the helical lobes during the casting of the screw rotor,
wherein an outer surface of the integral piece (2) is provided with an opening or a plurality of openings (4) extending into the internal cavity (3), and
wherein the opening or each of the plurality of openings (4) is adjacent to the helical grooves (5).

2. The sand core according to claim 1, wherein the internal cavity (3) is additionally bounded by the integral piece (2) by means of two end surfaces (6) that are configured to form the two head surfaces during the casting of the screw rotor.

3. The sand core according to claim 2, wherein the integral piece (2) is provided with two cylindrical holes (7), wherein each of the two cylindrical holes (7) is adjacent to the outer surface and one of the two end surfaces (6).

4. The sand core according to claim 1, wherein the helical grooves (5) are parallel helical.

5. The sand core according to claim 1, wherein the helical grooves (5) have a variable pitch.

6. The sand core according to claim 1, wherein a surface of the internal cavity (3) is at least partially provided with a coating and wherein the sand core (1) is provided with bleed holes for discharging excess coating material from the internal cavity (3) after providing the coating on the surface of the internal cavity (3).

7. A sand mold for casting a screw rotor, wherein the sand mold (8) contains a sand core according to claim 1.

8. The sand mold according to claim 7, wherein the sand mold (8) is provided with a degassing channel or a plurality of degassing channels (9) for degassing the internal cavity (3) in the sand core (1) during the casting of the screw rotor, wherein the degassing channel or each of the degassing channels (9) is connected to the opening or at least one of the plurality of openings (4) in the outer surface of the integral piece (2) of the sand core (1).

9. The sand mold according to claim 7, wherein the sand mold (8) is provided with a runner or a plurality of runners (11) for pouring a liquid casting material into the internal cavity (3) during the casting of the screw rotor, wherein the runner or each of the runners (11) is connected to the opening or at least one of the plurality of openings (4) in the outer surface of the integral piece (2) of the sand core (1).

10. The sand mold according claim 7, wherein the sand mold (8) contains a plurality of sand cores.

11. The sand mold according to claim 10, wherein the sand cores are arranged in the sand mold (8) according to a triangular arrangement pattern.

12. A method for manufacturing a sand core for casting a screw rotor, the screw rotor comprising a main body having two head surfaces and a profile surface having helical lobes extending between the two head surfaces,
wherein the sand core (1) is manufactured by means of an additive production technique.

13. The method according to claim 12, wherein the sand core (1) comprises an integral piece (2) having an internal cavity (3), wherein the internal cavity (3) is at least partially bounded by the integral piece (2) by means of a rotationally symmetric surface formed by helical grooves (5) about a rotationally symmetric axis, wherein the helical grooves (5) have a profile for forming the helical lobes during the casting of the screw rotor,
wherein an outer surface of the integral piece (2) is provided with an opening or a plurality of openings (4) extending into the internal cavity (3), and
wherein the opening or each of the plurality of openings (4) is adjacent to the helical grooves (5).

14. A method for casting a screw rotor, the screw rotor comprising a main body having two head surfaces and a profile surface having helical lobes extending between the two head surfaces,
wherein the method comprises the following steps:
filling a sand core (1) according to claim 1 with a molten casting material;
solidifying the casting material in the sand core (1) to form the screw rotor, wherein the helical lobes in the internal cavity (3) are formed by the profile of the helical grooves (5).

15. The method according to claim 14, wherein the aforementioned rotationally symmetric axis is oriented horizontally during the filling of the sand core (1).

16. The method according to claim 14, wherein,
a surface of the internal cavity (3) is at least partially provided with a coating before the filling of the sand core (1); and
excess coating material is removed from the internal cavity (3) after the coating is provided on the surface of the internal cavity (3) and before the filling of the sand core.

17. The method according to claim 14, wherein the internal cavity (3) is degassed through the opening or through one or more of the openings (4) during the filling of the sand core (1).

18. The method according to claim 14, wherein the molten casting material is poured into the internal cavity (3) through the opening or through one or more of the openings (4) during the filling of the sand core (1).
